(19) United States
(12) Patent Application Publication
(10) Pub. No.: US 2021/0147205 A1
(43) Pub. Date: May 20, 2021

(54) MOVABLE PLATFORM AND CONTROL METHOD THEREOF

(71) Applicant: SZ DJI TECHNOLOGY CO., LTD., Shenzhen (CN)

(72) Inventors: Shuai LIU, Shenzhen (CN); Liyuan LIU, Shenzhen (CN); Zhendong WANG, Shenzhen (CN)

(21) Appl. No.: 17/133,898

(22) Filed: Dec. 24, 2020

Related U.S. Application Data
(63) Continuation of application No. PCT/CN2018/093003, filed on Jun. 27, 2018.

(51) Int. Cl. B66F 17/00; B66F 7/28; G01C 9/06

(52) U.S. Cl. CPC B66F 17/006; G01C 9/06; B66F 7/28

(57) ABSTRACT

A control method of a movable platform includes obtaining current attitude information of a gimbal at the movable platform, determine whether the movable platform is in a tip-over state according to the current attitude information of the gimbal, and when the movable platform is in the tip-over state, switching the gimbal to a protection mode. The gimbal includes a shaft mechanism. The shaft mechanism includes a bracket and a motor. The motor is configured to drive the bracket. The protection mode includes powering off the motor of the gimbal.

### CROSS-REFERENCE TO RELATED APPLICATION

This application is a continuation of International Application No. PCT/CN2018/093003, filed Jun. 27, 2018, the entire content of which is incorporated herein by reference.

### TECHNICAL FIELD

The present disclosure relates to the photographing field and, more particularly, to a movable platform and a control method thereof.

### BACKGROUND

In the photographing field, a photographing trajectory of a gimbal is commonly controlled by the movement of a movable platform (e.g., remote-control vehicle). During the movement of the movable platform, the movable platform may tip over due to collision. When the movable platform is in a normal state (i.e., non-tip-over state), the gimbal operates normally, and a motor is in a closed-loop state. Thus, the motor provides power normally. After the movable platform tips over, the motor is in the closed-loop state and outputs a large torque, which causes the motor to stall. As such, the motor generates a large current and a lot of heat. In severe cases, this even causes the motor to be burned down.

### SUMMARY

Embodiments of the present disclosure provide a control method of a movable platform. The method includes obtaining current attitude information of a gimbal at the movable platform, determine whether the movable platform is in a tip-over state according to the current attitude information of the gimbal, and when the movable platform is in the tip-over state, switching the gimbal to a protection mode. The gimbal includes a shaft mechanism. The shaft mechanism includes a bracket and a motor. The motor is configured to drive the bracket. The protection mode includes powering off the motor of the gimbal.

Embodiments of the present disclosure provide a movable platform including a carrier body, a gimbal, an electronic speed control (ESC), and a controller. The carrier body is configured to move. The gimbal is carried at the carrier body and includes a shaft mechanism and a sensor. The shaft mechanism includes a bracket and a motor. The motor is configured to drive the bracket. The ESC is configured to communicate with the motor. The controller is configured to control the ESC and communicate with the sensor and the ESC. The sensor is configured to detect current attitude information of the gimbal and transmit the detected current attitude information of the gimbal to the controller. The controller is configured to determine whether the movable platform is in a tip-over state according to the current attitude information of the gimbal. When the movable platform is in the tip-over state, the gimbal is switched to a protection mode. The protection mode includes powering off the motor of the gimbal.

### BRIEF DESCRIPTION OF THE DRAWINGS

FIG. 1 is a schematic structural diagram of a movable platform according to some embodiments of the present disclosure.

FIG. 2 is a schematic operation flowchart of a control method of the movable platform according to some embodiments of the present disclosure.

FIG. 3 is a schematic operation flowchart of a specific control method of the movable platform according to some embodiments of the present disclosure.

FIG. 4 is a schematic diagram showing a coordinate relationship of the movable platform according to some embodiments of the present disclosure.

FIG. 5 is a schematic structural block diagram of the movable platform according to some embodiments of the present disclosure.

### DETAILED DESCRIPTION OF THE EMBODIMENTS

The technical solution of embodiments of the present disclosure is described in detail in connection with the accompanying drawings of embodiments of the present disclosure. Described embodiments are merely some embodiments of the present disclosure, not all embodiments. Based on embodiments of the present disclosure, all other embodiments obtained by those of ordinary skill in the art without creative efforts are within the scope of the present disclosure.

A control method and device of a movable platform of the present disclosure are described in detail in connection with the accompanying drawings. When there is no conflict, features of embodiments may be combined with each other.

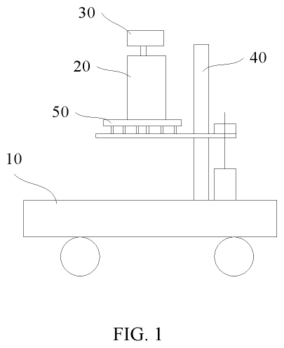

FIG. 1 is a schematic structural diagram of a movable platform according to some embodiments of the present disclosure. The movable platform includes a carrier body 10 and a gimbal 20. The carrier body 10 may move. In some embodiments, the carrier body 10 includes a roller, and the roller may include an omnidirectional wheel, such as a 45° omnidirectional wheel or a 90° omnidirectional wheel. Further, four omnidirectional wheels may be included.

The movable platform of embodiments of the present disclosure may include a remote-control vehicle, a handheld gimbal, etc. In the embodiments shown in the figure, the movable platform includes the remote-control vehicle.

In some embodiments, the carrier body 10 may be configured to carry the gimbal 20. The carrier body 10 may drive the gimbal 20 to move and rotate in any direction.

In some embodiments, the gimbal 20 is detachably connected to the carrier body 10. In some embodiments, a lifting mechanism 40 is arranged at the carrier body 10. The gimbal 20 is detachably connected to the lifting mechanism 40. Further, a damping mechanism 50 is arranged at a position where the gimbal 20 and the lifting mechanism 40 are connected.

The gimbal 20 is configured to carry a load 30. The load 30 may include an image acquisition device, a heat source device, a life-detection device, etc. In some embodiments, the load 30 may include the image acquisition device, which may include a camera. In some other embodiments, the image acquisition device may include another photographing device, such as an ultrasound imaging device.

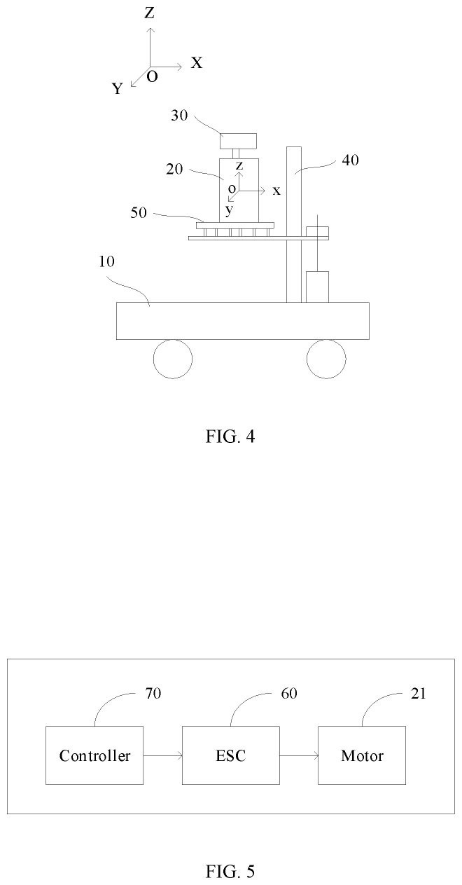

As shown in FIG. 1 and FIG. 5, in some embodiments, the gimbal 20 includes a shaft mechanism. The shaft mechanism may include a bracket (not shown) and a motor 21, which may be configured to drive the bracket. The load 30 may be fixedly connected to the bracket or the motor 21.

In some embodiments, the gimbal 20 may include a three-axis gimbal. The bracket may include a yaw axis bracket, a pitch axis bracket, and a roll axis bracket. The motor 21 may include a yaw axis motor, a pitch axis motor, and a roll axis motor. The yaw axis motor, the pitch axis motor, and the roll axis motor may drive the yaw axis bracket, the pitch axis bracket, and the roll axis bracket, correspondingly. In some other embodiments, the gimbal 20 may include a two-axis gimbal or a four-axis gimbal.

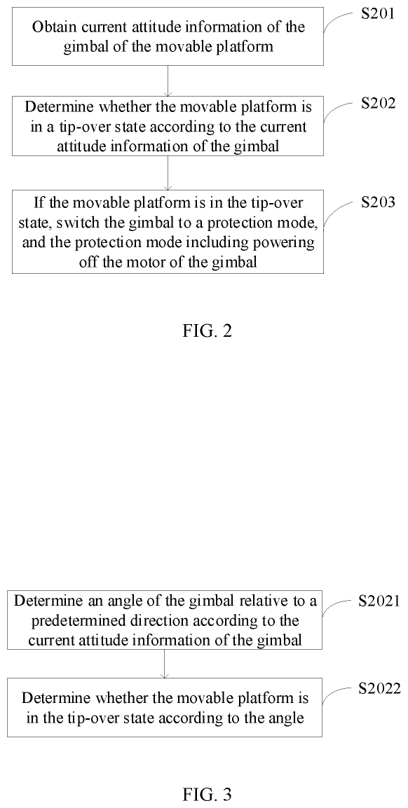

FIG. 2 is a schematic operation flowchart of a control method of the movable platform according to some embodiments of the present disclosure. As shown in FIG. 2, the control method of the movable platform includes the following processes.

At S201, current attitude information of the gimbal 20 of the movable platform is obtained.

In some embodiments, the gimbal 20 may include an inertial measurement unit (IMU). In some embodiments, in process S201, the current attitude information of the gimbal 20 may be obtained through the IMU. Further, the IMU may include a gyroscope and an accelerometer. In process S201, an angular speed of the gimbal 20 may be obtained through the gyroscope, and an acceleration of the gimbal 20 may be obtained through the accelerometer. Then, the current attitude information of the gimbal 20 may be determined according to the angular speed and the acceleration. In some embodiments, the gyroscope may be configured to measure angular speeds of the axes of the gimbal 20. By performing integration on the measured angular speeds, a current attitude (pitch, roll, and yaw) of the gimbal 20 may be determined. Then, the accelerometer may be configured to provide an attitude reference of the gimbal 20 to correct the current attitude of the gimbal 20 obtained by integrating the angular speeds measured by the gyroscope. As a result, the gimbal 20 may obtain a relatively stable attitude. The acquisition manner of the current attitude information of the gimbal 20 may not be limited as described above, and other manners may be implemented.

Attitude information may be in one of a plurality of representation forms. Quaternion may be one representation form of the attitude information. In addition, common expression forms of a commonly used attitude may include Euler angle, matrix, etc. The attitude information may include an attitude angle (e.g., Euler angle) of the gimbal attitude or a quaternion corresponding to the gimbal attitude, which may not be limited here. The attitude information described in the later part of the specification may include the attitude angle corresponding to the gimbal attitude or the quaternion corresponding to the gimbal attitude, which are not described here again.

At S202, whether the movable platform is in a tip-over state is determined according to the current attitude information of the gimbal 20. For example, when the movable platform includes the remote-control vehicle, whether the remote-control vehicle is in the tip-over state may be determined.

In some embodiments, as shown in FIG. 3, process S202 includes the following processes.

At S2021, an angle of the gimbal 20 relative to a predetermined direction is determined according to the current attitude information of the gimbal 20. In this disclosure, this angle is also referred to as a “gimbal orientation angle.”

At S2022, whether the movable platform is in the tip-over state is determined according to the angle.

In some embodiments, before process S2021, a body coordinate system of the gimbal 20 may be determined. The body coordinate system may include a yaw axis. For example, as the three-axis gimbal shown in FIG. 4, the body coordinate system is defined as oxyz. The origin o of the coordinate system may be a geometrical center of a plane, at which the gimbal 20 is connected to the load 30. The x-axis is the roll axis of the three-axis gimbal. The y-axis is the pitch axis of the three-axis gimbal. The z-axis is the yaw axis of the three-axis gimbal. Determination of the body coordinate system may not be limited above. For example, the origin o of the coordinate system may also be a geometrical center of a plane, at which, the gimbal 20 is connected to the moving carrier 10.

In some embodiments, in process S2021, an included angle between the yaw axis of the body coordinate system and the predetermined direction may be determined according to the current attitude information of the gimbal 20. Then, the angle of the gimbal 20 relative to the predetermined direction may be determined according to the included angle between the yaw axis of the body coordinate system and the predetermined direction. In some embodiments, the angle of the gimbal 20 relative to the predetermined direction may be equal to the included angle between the yaw axis of the body coordinate system and the predetermined direction. In some other embodiments, the angle of the gimbal 20 relative to the predetermined direction may be obtained according to the included angle between the yaw axis of the body coordinate system and the predetermined direction and an empirical parameter.

Further, the predetermined direction may be set manually. For example, the predetermined direction may be set to a moving direction of the remote-control vehicle or a vertical direction of the global coordinate system (i.e., a navigation coordinate system). In some embodiments, the predetermined direction may include the vertical direction of the global coordinate system. Refer again to FIG. 4, the global coordinate system is OXYZ. Z is the vertical direction. In some embodiments, the included angle between the yaw axis of the body coordinate system and the vertical direction of the global coordinate system may be determined according to the current attitude information of the gimbal 20.

The included angle between the yaw axis of the body coordinate system and the vertical direction of the global coordinate system may be calculated through the following processes.

1. A conversion relationship between the body coordinate system and the global coordinate system is determined according to the current attitude information of the gimbal 20.

2. A first unit vector of the gimbal 20 at the yaw axis of the body coordinate system is converted to a second unit vector of the global coordinate system according to the conversion relationship.

3. The included angle between the yaw axis of the body coordinate system and the vertical direction of the global coordinate system is determined according to the second unit vector and a third unit vector of the gimbal 20 in the vertical direction of the global coordinate system direction.

Determining the included angle between the yaw axis of the body coordinate system and the vertical direction of the global coordinate system according to the second unit vector and a third unit vector of the gimbal 20 in the vertical direction of the global coordinate system direction includes determining a cosine value of the included angle between the yaw axis and the vertical direction according to the second unit vector and the third unit vector, and then, determining a magnitude of the included angle according to the cosine value.

In process S2022, when the angle is in a predetermined first angle range, the movable platform may be determined to be in the tip-over state. When the angle is in a predetermined second angle range, the movable platform may be determined to be in the normal state.

In some embodiments, the conversion relationship between the body coordinate system and the global coordinate system may be a rotation matrix D. In some embodiments, the current attitude information of the gimbal 20 may be represented by a quaternion. The rotation matrix D may be obtained according to the quaternion corresponding to the current attitude information.

After the body coordinate system of the gimbal 20 is determined, no matter whether the movable platform is in the normal state or in the tip-over state, the first unit vector \vec{B}_{b} of the gimbal 20 at the yaw axis of the body coordinate system may be (0, 0, 1). If the movable platform is in the normal state, the third unit vector \vec{Z}_{w} of the gimbal 20 at the Z-axis of the global coordinate system may be (0, 0, 1). The third unit vector may be obtained by converting the first unit vector in the global coordinate system. After the movable platform is tipped over, the first unit vector may be converted in the global coordinate system to obtain the second unit vector \vec{B}_{w} according to the rotation matrix D. The included angle between the yaw axis of the body coordinate system and the vertical direction of the global coordinate system may be the included angle θ between the second unit vector and the third unit vector.

\vec{B}_{w}=D·\vec{B}_{b};

cos θ=\vec{B}_{w}*\vec{Z}_{w}=tilt_coef;

where tilt_coef denotes the cosine value of the included angle θ, and * denotes a dot product of the two vectors.

In some embodiments, the magnitude of the included angle may be determined according to the cosine value to determine the magnitude of the angle. In some embodiments, when 0<cosine value≤1, the included angle may be determined to be in the range of (0, 90°], that is, the angle may be in the range of (0, 90°]. Thus, the movable platform is in the normal state. When −1≤cosine value≤0, the included angle may be determined to be in the range of [−90°, 0], that is, the angle may be in the range of [−90°, 0]. Thus, the movable platform is in the tip-over state.

At S203, if the movable platform is in the tip-over state, the gimbal 20 is switched to a protection mode, and the protection mode includes powering off the motor 21 of the gimbal 20.

The motor 21 of the gimbal 20 is powered off, that is, the motor 21 is controlled to cause the torque output by the motor 21 to be zero. A plurality of manners may be implemented to power off the motor 21. For example, in some embodiments, an amplitude of a drive signal of the motor 21 may be reduced to zero to cause the torque output by the motor 21 to be zero. In some other embodiments, the power source of the motor 21 may be cut off to cause the motor 21 to stop working and the torque output by the motor 21 to be zero.

In some other embodiments, the protection mode may include controlling the torque output by the motor 21 to be smaller than a torque threshold. By controlling the torque output by the motor 21 to be smaller than the torque threshold to replace powering off the motor 21 of the gimbal 20 of embodiments of the present disclosure, heat dissipation of the motor 21 may be reduced to lower the risk of burning down the motor 21. In some embodiments, the torque output by the motor 21 may be caused to be smaller than the torque threshold by controlling the amplitude of the drive signal of the motor 21. The torque threshold may be smaller than an output torque of the motor 21 corresponding to a temperature of the motor 21 when being burned down. Compared to the manner of powering off the motor 21 of the gimbal 20, an effect of the manner of controlling the torque output by the motor 21 to be smaller than the torque threshold may have poor safety.

In addition, after the gimbal 20 is switched to the protection mode, if the movable platform is determined to be in the normal state according to the current attitude information of the gimbal 20, the gimbal 20 may be switched to the operation mode. The operation mode may include driving the motor 21 to rotate to cause the movable platform to recover the normal operation. In some embodiments, the angle of the gimbal 20 relative to the predetermined direction may be determined according to the current attitude information of the gimbal 20. When the angle is in the predetermined second angle range, the movable platform may be determined to be in the normal state. For the processes of determining whether the movable platform is in the normal state, reference may be made to embodiments above, which is not repeated here.

In the control method of the movable platform of embodiments of the present disclosure, after the movable platform is tipped over, the gimbal 20 may be controlled to enter the protection mode to powering off the motor 21. Thus, the motor 21 may not stall and be burned down due to the tip-over of the movable platform.

The present disclosure further provides embodiments of the movable platform corresponding to embodiments of the control method of the movable platform of the present disclosure.

Refer to FIG. 1 and FIG. 5, embodiments of the present disclosure further provide the movable platform, the movable platform includes the carrier body 10 and the gimbal 20. The carrier body 10 may move. The gimbal 20 is carried by the carrier body 10. The gimbal 20 may include the shaft mechanism and a sensor. The shaft mechanism may include the bracket and the motor 21 configured to drive the bracket. The movable platform further includes an electronic speed control (ESC) 60 and a controller 70 configured to control the ESC 60. The ESC 60 communicates with the motors 21. The controller 70 may communicate with both the sensor and the ESC 60. The controller 70 may cooperate with the ESC 60 to control the motor 21 to operation, which is not described in detail in embodiments of the present disclosure.

The movable platform may include the remote-control vehicle, handheld gimbal, etc. In the embodiments shown in the figures, the movable platform includes the remote-control vehicle.

One or more controllers 70 may operate individually or collectively. The controller 70 may be arranged at the gimbal 20 or the carrier body 10. When the controller 70 is arranged at the gimbal 20, the controller 70 may be an internal controller of the gimbal 20. When the controller 70 is arranged at the carrier body 10, the controller 70 may be a main controller of the movable platform.

The sensor may be configured to detect the current attitude information of the gimbal 20. The sensor may transmit the detected current attitude information of the gimbal 20 to the controller 70. The controller 70 may be configured to determine whether the movable platform is in the tip-over state according to the current attitude information of the gimbal 20. When the movable platform is in the tip-over state, the gimbal 20 may be switched to the protection mode. The protection mode may include powering off the motor 21 of the gimbal 20.

Further, the controller 70 may include a central processing unit (CPU). The controller 70 may further include a hardware chip. The hardware chip may include an application-specific integrated circuit (ASIC), a programmable logic device (PLD), or a combination thereof. The PLD may include a complex programmable logic device (CPLD), a field-programmable gate array (FPGA), a generic array logic (GAL), or a combination thereof.

In some embodiments, the sensor may include an IMU. The controller 70 may be configured to obtain the current attitude information of the gimbal 20 through the IMU.

In some embodiments, the IMU may include the gyroscope and the accelerometer. The controller 70 may obtain the angular speed of the gimbal 20 through the gyroscope and obtain the acceleration of the gimbal 20 through the accelerometer. The current attitude information of the gimbal 20 may be determined according to the angular speed and the acceleration.

In some embodiments, the controller 70 may be configured to determine the angle of the gimbal 20 relative to the predetermined direction according to the current attitude information of the gimbal 20 and determine whether the movable platform is in the tip-over state according to the angle.

In some embodiments, before determining the angle of the gimbal 20 relative to the predetermined direction according to the current attitude information of the gimbal 20, the controller 70 may be configured to determine the body coordinate system of the gimbal 20. The body coordinate system may include the yaw axis. The controller 70 determining the angle of the gimbal 20 relative to the predetermined direction according to the current attitude information of the gimbal 20 includes determining the included angle between the yaw axis of the body coordinate system and the predetermined direction according to the current attitude information of the gimbal 20, and determining the angle of the gimbal 20 relative to the predetermined direction according to the included angle between the yaw axis of the body coordinate system and the predetermined direction.

In some embodiments, the controller 70 may be configured to determine the included angle between the yaw axis of the body coordinate system and the vertical direction of the global coordinate system according to the current attitude information of the gimbal 20.

In some embodiments, the controller 70 may be configured to determine the conversion relationship between the body coordinate system and the global coordinate system according to the current attitude information of the gimbal 20, determine that the first unit vector of the gimbal 20 at the yaw axis of the body coordinate system is converted to the second unit vector of the global coordinate system according to the conversion relationship, and determine the included angle between the yaw axis of the body coordinate system and the vertical direction of the global coordinate system according to the second unit vector and the third unit vector of the gimbal 20 in the vertical direction of the global coordinate system.

In some embodiments, the controller 70 may be configured to determine the cosine value of the included angle between the yaw axis and the vertical direction according to the second unit vector and the third unit vector and determine the magnitude of the included angle according to the cosine value.

In some embodiments, the controller 70 may determine the movable platform to be in the tip-over state when the angle is in the predetermined first angle range.

In some embodiments, the controller 70 may be configured to reduce the amplitude of the drive signal of the motor 21 to zero or cut off the power source of the motor 21.

In some embodiments, the controller 70 may, after switching the gimbal 20 to the protection mode, when the movable platform is determined to be in the normal state according to the current attitude information of the gimbal 20, switch the gimbal 20 to the operation mode. The operation mode may include driving the motor 21 to rotate.

In some embodiments, the controller 70 may determine the angle of the gimbal 20 relative to the predetermined direction according to the current attitude information of the gimbal 20 and determine the movable platform to be in the normal state when the angle is in the predetermined second angle range.

The working principle of the movable platform is similar to the working principle of the control method of the movable platform, which is not repeated here.

Further, the movable platform may further include a storage device. The storage device may include volatile memory, such as random-access memory (RAM). The storage device may also include non-volatile memory, such as flash memory, a hard disk drive (HDD), or a solid-state drive (SSD). The storage device may further include a combination of above described storage devices. In some embodiments, the storage device stores the program instruction. the controller 70 may call the program instruction to implement the control method of the movable platform of embodiments above.

In embodiments of the present disclosure, after the movable platform tipped over, the gimbal 20 may be controlled to enter the protection mode to power off the motor 21. Thus, the motor 21 may not stall and be burned down due to the tip-over of the movable platform.

In addition, embodiments of the present disclosure may further provide a computer-readable storage medium. The computer-readable storage medium stores a computer program. When the program is executed by the controller 70, the processes of the control method of the movable platform of embodiments above may be implemented.

Those of ordinary skill in the art may understand that all or a part of the processes that implement method embodiments above may be completed by instructing related hardware by the computer program. The program may be stored in the computer-readable storage medium. When the program is executed, processes of method embodiments above may be implemented. The storage medium may include a magnet disc, an optical disc, a read-only memory (ROM), or a random access memory (RAM).

Above disclosed are merely some embodiments of the present disclosure, which may not be used to limit the scope of the claims of the invention. Equivalent modifications made according to the claims of the invention are still within the scope of the invention.

What is claimed is:

1. A control method of a movable platform comprising:
obtaining current attitude information of a gimbal at the movable platform, the gimbal including a shaft mechanism, and the shaft mechanism including a bracket and a motor configured to drive the bracket;
determining whether the movable platform is in a tip-over state according to the current attitude information of the gimbal; and
in response to the movable platform being in the tip-over state, switching the gimbal to a protection mode, the protection mode including powering off the motor of the gimbal.

2. The method of claim 1, wherein obtaining the current attitude information of the gimbal includes:
obtaining the current attitude information of the gimbal through an inertial measurement unit (IMU).

3. The method of claim 2, wherein:
the IMU includes a gyroscope and an accelerometer; and
obtaining the current attitude information of the gimbal through the IMU includes:
obtaining an angular speed of the gimbal through the gyroscope;
obtaining an acceleration of the gimbal through the accelerometer; and
determining the current attitude information of the gimbal according to the angular speed and the acceleration.

4. The method of claim 1, wherein determining whether the movable platform is in the tip-over state according to the current attitude information of the gimbal includes:
determining a gimbal orientation angle of the gimbal relative to a predetermined direction according to the current attitude information of the gimbal; and
determining whether the movable platform is in the tip-over state according to the gimbal orientation angle.

5. The method of claim 4, further comprising, before determining the gimbal orientation angle:
determining a body coordinate system of the gimbal including a yaw axis;
wherein determining the gimbal orientation angle includes:
determining an included angle between the yaw axis and the predetermined direction according to the current attitude information of the gimbal; and
determining the gimbal orientation angle according to the included angle between the yaw axis and the predetermined direction.

6. The method of claim 5, wherein determining the included angle between the yaw axis and the predetermined direction includes:
determining an included angle between the yaw and a vertical direction of a global coordinate system according to the current attitude information of the gimbal.

7. The method of claim 6, wherein determining the included angle between the yaw axis and the vertical direction of the global coordinate system includes:
determining a conversion relationship between the body coordinate system and the global coordinate system according to the current attitude information of the gimbal;
converting a first unit vector of the gimbal at the yaw axis to a second unit vector of the global coordinate system; and
determining the included angle between the yaw axis and the vertical direction of the global coordinate system according to the second unit vector and a third unit vector of the gimbal in the vertical direction of the global coordinate system.

8. The method of claim 7, wherein determining the included angle between the yaw axis and the vertical direction of the global coordinate system according to the second unit vector and the third unit vector includes:
determining a cosine value of the included angle between the yaw axis and the vertical direction according to the second unit vector and the third unit vector; and
determining a magnitude of the included angle between the yaw axis and the vertical direction according to the cosine value.

9. The method of claim 4, wherein determining whether the movable platform is in the tip-over state according to the gimbal orientation angle includes:
in response to the gimbal orientation angle being in a predetermined angle range, determining that the movable platform is in the tip-over state.

10. The method of claim 1, wherein powering off the motor of the gimbal includes:
reducing an amplitude of a drive signal of the motor to zero; or
cutting off a power source of the motor.

11. The method of claim 1, further comprising, after the gimbal is switched to the protection mode:
determining that the movable platform is in a normal state according to the current attitude information of the gimbal; and
switching the gimbal to an operation mode, the operation mode including driving the motor to rotate.

12. The method of claim 11, wherein determining that the movable platform is in the normal state according to the current attitude information of the gimbal includes:
determining a gimbal orientation angle of the gimbal relative to a predetermined direction according to the current attitude information of the gimbal; and
in response to the angle being in a predetermined angle range, determining that the movable platform is in the normal state.

13. A movable platform comprising:
a carrier body configured to move;
a gimbal carried at the carrier body and including a shaft mechanism and a sensor, the shaft mechanism including a bracket and a motor configured to drive the bracket;
an electronic speed control (ESC) configured to communicate with the motor; and
a controller configured to control the ESC and communicate with the sensor and the ESC;
wherein:
the sensor is configured to detect current attitude information of the gimbal and transmit the detected current attitude information of the gimbal to the controller; and
the controller is configured to:
determine whether the movable platform is in a tip-over state according to the current attitude information of the gimbal; and
in response to the movable platform being in the tip-over state, switch the gimbal to a protection mode, the protection mode including powering off the motor of the gimbal.

14. The movable platform of claim 13, wherein:
the sensor includes an inertial measurement unit (IMU); and
the controller is configured to obtain the current attitude information of the gimbal through the IMU.

15. The movable platform of claim 14, wherein:
the IMU includes a gyroscope and an accelerometer; and
the controller is further configured to:
obtain an angular speed of the gimbal through the gyroscope;
obtain an acceleration of the gimbal through the accelerometer; and
obtain the current attitude information of the gimbal according to the angular speed and the acceleration.

16. The movable platform of claim 13, wherein the controller is further configured to:
determine a gimbal orientation angle of the gimbal relative to a predetermined direction according to the current attitude information of the gimbal; and
determine whether the movable platform is in the tip-over state according to the gimbal orientation angle.

17. The movable platform of claim 16, wherein the controller is further configured to:
before determining the gimbal orientation angle, determine a body coordinate system of the gimbal including a yaw axis;
determine an included angle between the yaw axis and the predetermined direction according to the current attitude information of the gimbal; and
determine the gimbal orientation angle according to the included angle between the yaw axis and the predetermined direction.

18. The movable platform of claim 17, wherein the controller is further configured to:
determine an included angle between the yaw axis and a vertical direction of a global coordinate system according to the current attitude information of the gimbal.

19. The movable platform of claim 18, wherein the controller is further configured to:
determine a conversion relationship between the body coordinate system and the global coordinate system according to the current attitude information of the gimbal;
convert a first unit vector of the gimbal at the yaw axis to a second unit vector of the global coordinate system; and
determine the included angle between the yaw axis and the vertical direction of the global coordinate system according to the second unit vector and a third unit vector of the gimbal in the vertical direction of the global coordinate system.

20. The movable platform of claim 19, wherein the controller is further configured to:
determine a cosine value of the included angle between the yaw axis and the vertical direction of the global coordinate system according to the second unit vector and the third unit vector; and
determine a magnitude of the included angle between the yaw axis and the vertical direction according to the cosine value.
